(19) United States
(12) Patent Application Publication
(10) Pub. No.: US 2022/0005053 A1
(43) Pub. Date: Jan. 6, 2022

(54) SOCIAL MEDIA NETWORK MINING

(71) Applicant: Wells Fargo Bank, N.A., San Francisco, CA (US)

(72) Inventors: Swapna Gurugubelli, Visakhapatnam (IN); Priyansha Mudaliar, Hyderabad (IN); Rameshchandra Bhaskar Ketharaju, Hyderabad (IN)

(21) Appl. No.: 15/812,739

(22) Filed: Nov. 14, 2017

Related U.S. Application Data
(60) Provisional application No. 62/554,853, filed on Sep. 6, 2017.

(51) Int. Cl. G06Q 30/02; G06Q 30/06; G06Q 50/00; G06F 17/30

(52) U.S. Cl. CPC G06Q 30/0201; G06Q 30/0224; G06Q 30/0269; G06F 17/30699; G06Q 50/01; G06F 17/30867; G06Q 30/0631

(57) ABSTRACT

A customer who manages a social media service may interact with a business regarding a product. A computerized system associated with the business may detect this interaction and analyze a social media network of the customer on the social media service. The system may identify a set of users that are connected to the customer on the social media network with high potential to promote and/or consume the product of the business. The system may track social media messages sent to these users by the customer regarding the product as the social media messages traverse through the social media service and result in sales. The system may provide an incentive to the customer in response to the social media message resulting in a sale.

This application claims the benefit of U.S. Provisional Application Ser. No. 62/554,853, filed Sep. 6, 2017, the entire content of which is incorporated herein by reference.

### TECHNICAL FIELD

The invention relates to a computerized analysis of data stored on social media services.

### BACKGROUND

Many people use social media services in either a personal or professional capacity. On social media services, a user may create a social media network by creating virtual connections with acquaintances, colleagues, friends, family, or virtual “followers” who read, watch, or otherwise consume the content of the user's social media network (e.g., where a social media network relates to connections and communications between a particular user and a set of users on a particular social media service). Frequently, users may post messages on their social media networks. These messages may be private messages for a single other user of the social media network, public messages for a single other user of the social media network (e.g., a public message in which a single other user is tagged, or messages publicly posted on another user's profile or page), private messages for a group of users of the social media network, or public messages for all users of the social media network. Further, users may interact over public messages through such actions as liking, favoriting, commenting on, or forwarding content of the public messages.

### SUMMARY

In general, this disclosure describes techniques for computerized analysis of data of a social media network. A customer who manages a social media service may interact with a business to view, research, and/or purchase a given product. A computerized system associated with the business may detect this interaction and analyze the social media network of the customer on the social media service. The system may identify a set of users that are connected to the customer on the social media network with high potential to promote and/or consume products of the business. The system may further select the identified users by quantifying the connection between the customer and the users with high consumption potential by determining an “influence” of the customer related to the users. In response to an incentive sent to the customer, the customer may send a social media message that relates to products of the business to the identified set of users. The system may track the social media message by building a blockchain database of interactions, inquiries, and purchases that result from the message (e.g., by tracking a token embedded in the social media message). Alternatively, or additionally, the system may track the social media message by correlating details of the social media message against data of internal or external databases, such as an internal transactional database (e.g., a database of transactions of the products of the business) or a public blockchain database (e.g., a bitcoin database or the like).

Additionally, the system may analyze the social media networks of one or more of the identified users to identify a set of potential future customers. For example, after navigating through and gathering data from a first social media network of the customer, the system may then navigate through and gather data from a second, third, and fourth social media network of a second, third, and fourth user that are each connected to the customer (e.g., connected within the first social media network) to identify if the second, third, or fourth users are connected to other potential future customers. The system or business may track social media messages to the potential customers within the social media networks. The system may use public and/or private data to detect purchases resulting from the social media messages. In this way, the system may analyze social media networks to determine users that are connected to current customers that may promote as well as consume products, and then track and confirm an ability of users of the social media service to successfully sell a product, therein potentially improving an ability of the system to identify influential users and/or potential future customers.

In one example, this disclosure is directed to a computer-implemented method for mining social media networks that includes gathering, by a computing device and in response to a triggering event relating to one or more products and a customer that manages a social media network on a social media service, social media data from the social media network of the customer, the social media network including a set of users that are virtually connected to the customer on the social media service, the social media data related to the set of users. The computer-implemented method further includes determining, by the computing device and using the gathered social media data, a subset of the set of users that satisfy a correlation threshold indicating an interest in the one or more products and an association threshold indicating an influence of the customer. The computer-implemented method further includes tracking, by the computing device and in a database, one or more social media messages sent to users of the subset of users by the customer using the social media service, the one or more social media messages relating to the one or more products. The computer-implemented method further includes detecting, by the computing device, one or more records of sale for the one or more products and performed by the users of the subset of users in response to the one or more social media messages tracked in the database. The computer-implemented method further includes providing, by the computing device, an incentive to the customer in response to the one or more records of sale, wherein the incentive is proportional to the number of records of sale performed in response to the one or more social media messages tracked in the database.

In another example, this disclosure is directed to a computing device comprising at least one processor and a memory coupled to the processor, the memory storing instructions that, when executed, cause the at least one processor to gather, in response to a triggering event relating to one or more products and a customer that manages a social media network on a social media service, social media data from the social media network of the customer, the social media network including a set of users that are virtually connected to the customer on the social media service and the social media data related to the set of users. The memory further storing instructions that, when executed, cause the at least one processor to determine, using the gathered social media data, a subset of the set of users that satisfy a correlation threshold indicating an interest in the one or more products and an association threshold indicating an influence of the customer. The memory further storing instructions that, when executed, cause the at least one processor to track, in a database, one or more social media messages sent to users of the subset of users by the customer using the social media service, the one or more social media messages relating to the one or more products. The memory further storing instructions that, when executed, cause the at least one processor to detect one or more records of sale for the one or more products and performed by the users of the subset of users in response to the one or more social media messages tracked in the database. The memory further storing instructions that, when executed, cause the at least one processor to provide an incentive to the customer in response to the one or more records of sale, wherein the incentive is proportional to the number of records of sale performed in response to the one or more social media messages tracked in the database.

In a further example, this disclosure is directed to a non-transitory computer-readable storage medium having stored thereon instructions that, when executed, cause a processor to gather, in response to a triggering event relating to one or more products and a customer that manages a social media network on a social media service, social media data from the social media network of the customer, the social media network including a set of users that are virtually connected to the customer on the social media service and the social media data related to the set of users. The non-transitory computer-readable storage medium further including instructions that, when executed, further cause the processor to determine, using the gathered social media data, a subset of the set of users that satisfy a correlation threshold indicating an interest in the one or more products and an association threshold indicating an influence of the customer. The non-transitory computer-readable storage medium further including instructions that, when executed, further cause the processor to track, in a database, one or more social media messages sent to users of the subset of users by the customer using the social media service, the one or more social media messages relating to the one or more products. The non-transitory computer-readable storage medium further including instructions that, when executed, further cause the processor to detect one or more records of sale for the one or more products and performed by the users of the subset of users in response to the one or more social media messages tracked in the database. The non-transitory computer-readable storage medium further including instructions that, when executed, further cause the processor to provide an incentive to the customer in response to the one or more records of sale, wherein the incentive is proportional to the number of records of sale performed in response to the one or more social media messages tracked in the database

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example social media network management system that includes a computing device, a customer device, and one or more databases, in accordance with the techniques of this disclosure

FIG. 2 is a block diagram illustrating an example computing device for automated mining of social media networks, in accordance with the techniques of this disclosure.

FIG. 3 is a conceptual diagram illustrating a set of overlapping social media networks of social media service users that can be managed by the computing device of FIGS. 1 and 2, in accordance with the techniques of this disclosure.

FIG. 4 is a flowchart illustrating an example method of mining social media networks in accordance with the techniques of this disclosure.

### DETAILED DESCRIPTION

Aspects of the disclosure are related to systems and methods for mining a social media service to identify groups of users that may consume and/or promote one or more products. Users of social media services may manage personal or professional social media networks on the social media service. Within these social media networks, users may virtually connect to and/or interact with a plurality of users. In response to a triggering event relating to a customer that is also a user of social media services, a social media network of the customer can be mined. The triggering event may relate to a sale event, a pre-sale event, or a post-sale event between the customer and a business.

A computer controller (e.g., a software module on a computing device that has access to social media service data and financial data) may traverse to multiple levels of customer's social media network to identify users as potential consumers or promoters for the business. The controller may use a mining algorithm to fetch unique or distinct user profiles from multiple circles or networks that are connected to the customer in one or more social media services (e.g., Facebook, Instagram, Pinterest, Twitter). The mining algorithm may provide a finite set of users with the potential to consume and/or promote the services or products of that business. The mining algorithm may apply different criteria to create this finite set of users from the social media network(s). These criteria may include demographic profiles, regional statistics, professional statistics, spending behavior, or the like.

According to the disclosed techniques, mining the social media network of the customer may include traversing horizontally from the customer (e.g., analyzing a first set of users that are directly connected with the customer) and/or vertically from the customer (e.g., analyzing a second set of users that are connected to the first set of users, or a third set connected to the second set, etc.). Potential customers of the business may be identified as users that correlate with one or more products and associate with the customer of the triggering event. The customer may send a social media message to the subset of users related to the one or more products, and the computer controller may track the social media message to analyze and identify additional users to promote the same one or more products or additional products. The computer controller may track the social media message by building a database (e.g., using blockchain technology) that details each action of the social media message, from posting to commenting to inquiry with the business to sale with the business. Additionally, or alternatively, the computer controller may track the social media message by referencing existing databases that store ongoing transactions, such as a private internal transactional database or a public transaction database (e.g., a blockchain database such as a bitcoin database).

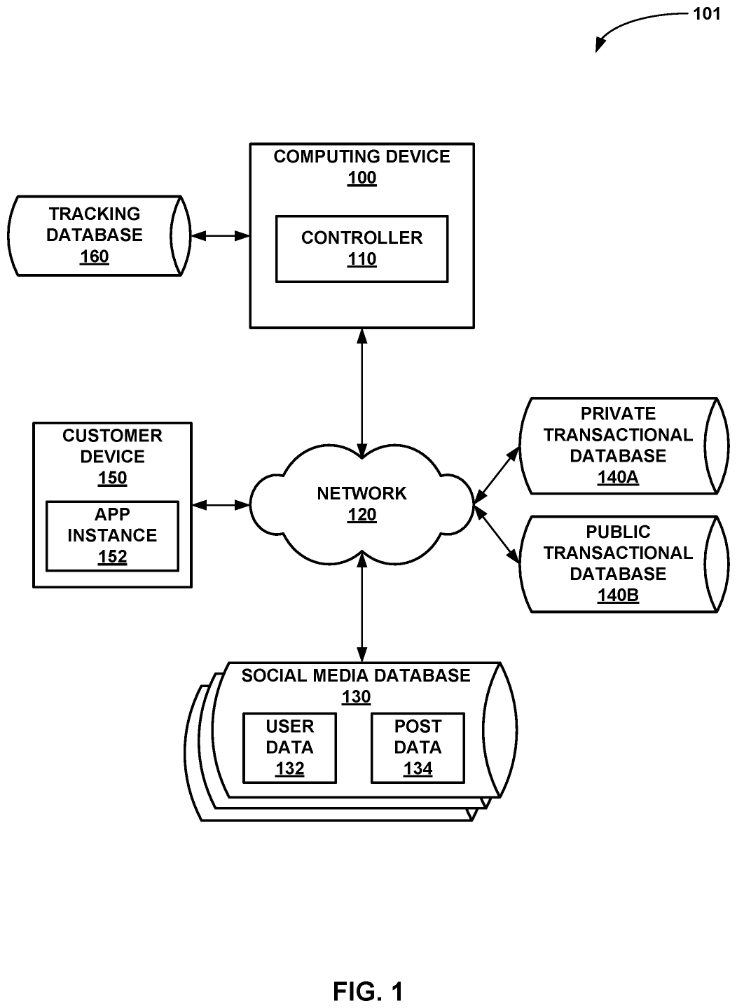

FIG. 1 is a block diagram illustrating a system 101 in which an example computing device 100 mines social media databases 130 over network 120 in order to determine a set of users to which products may be marketed. Computing device 100 may comprise a cluster of one or more computers, workstations, servers, and the like. Computing device 100 may be owned or otherwise used by an organization or business that mines social media databases 130 over network 120 in order to determine a set of users. For example, computing device 100 may be physically or virtually included within an internal network of the organization or business. Alternatively, computing device 100 may be physically or virtually included in a network hosted by a third-party vendor and therein used by the organization or business. For example, a vendor of the organization or business may store and maintain controller 110 for the organization or business and/or may provide the functions of controller 110 as a service to the organization or business.

Computing device 100 may be connected to network 120. Network 120 may comprise a private network including, for example, a private network associated with a financial institution. Alternatively, network 120 may comprise a public network, such as the Internet. Although illustrated in FIG. 1 as a single entity, in other examples network 120 may comprise a combination of public and/or private networks.

Computing device 100 may track marketing efforts by creating tracking database 160. Tracking database 160 may utilize blockchain technology to create a record of events that result from marketing efforts. By using blockchain technology to create tracking database 160, computing device 100 may reliably analyze and reference tracking database 160 data over time (e.g., as tracking database 160 acquires more information) to accurately determine a subset of users for marketing purposes. Though in FIG. 1 tracking database 160 is depicted as directly connected to computing device 100, in other examples computing device 100 may access tracking database 160 over network, or tracking database 160 may be incorporated into computing device 100 (e.g., tracking database 160 may be stored within the memory of computing device 100).

Additionally, or alternatively, computing device 100 may track marketing efforts using various financial databases accessed over network 120, such as private transactional databases 140A that are substantially only available to the organization or business of computing device 100 or public transactional databases 140B such as public-ledger databases that utilize blockchain technology to store transactional data (e.g., a bitcoin database that publicly and reliably stores some details of transactions between two private parties). Computing device 100 may use these third-party databases to enable a business associated with computing device 100 to improve its marketing efforts over time in accordance with the techniques of this disclosure.

Additionally, or alternatively, computing device 100 may use private transactional databases 140A and/or public transactional databases 140B to identify additional users to which to market its products. Computing device 100 may execute controller 110 configured to mine one or more social media networks of a customer of the business associated with computing device 100. Controller 110 may be a software module stored in the memory of computing device 100. Controller 110 may connect to a network 120 to access one or more external databases to mine social media networks.

Social media networks may be hosted or provided by social media services. Social media services may be the platform on which a user may build or otherwise manage social media networks. Social media services may include Facebook, Twitter, Instagram, Snapchat, or the like. A user may manage one or more social media networks on one or more social media services.

A social media network may be a unique set of connections between a single online entity (e.g., a profile or avatar or online handle) and one or more other online entities. For example, a customer “Bill Smith” may have a social media network in which Bill is virtually connected to virtual entities “Anne Johnson” and “David Santana,” (e.g., both of which are managed by respective human users of the same name). Anne and David may also manage unique social media networks in which Anne and David connect and/or communicate with other unique entities. In this way, an initial customer may maintain a social network in which the customer connects with a set of users that themselves each may maintain social media networks, such that, through a first customer, a business gains access to a plurality of users across a plurality of distinct social media networks that interconnect, overlap, and/or extend away from each other.

In some examples, Bill's virtual connections with Anne and David may enable Bill sending messages to Anne and David, posting content for Anne and David, consuming content posted by Anne and David, or the like. In certain examples, Bill may be able to communicate with and consume substantially all content of substantially every entity of the social media service with or without being connected to these entities. In other examples, Bill may need to be connected to an entity in order for Bill to communicate with and consuming content of that entity, or Bill may need to be connected to an entity in order for Bill to communicate with and consume content of that entity without restriction (e.g., such that Bill can only communicate in some forms or consume some content of an entity that Bill is not connected to). Controller 110 may be aware of any such communication restrictions imposed on a customer (e.g., Bill) on respective social media services, and may determine subsets of users for respective customers to communicate with accordingly.

Additionally, or alternatively, users may connect to group entities (e.g., social media profiles that indicate a group of people, such as a corporation, organization, or social group or the like). Social media services may enable group entities to connect to and interact with individual entities (e.g., Bill Smith) in much the same ways as individual entities interact with each other.

Data of the social media services may be stored on one or more social media databases 130. As discussed herein, each social media database 130 may store substantially all social media data for a single social media service. For example, a single social media database 130 that relates to a single social media service may store data for each user that utilizes the respective social media service, such that each social media service utilizes a different social media database 130. In other examples, each social media database 130 may store social media data on a single user. This data of social media databases 130 may include user data 132 and post data 134. User data 132 may include identifying information related to respective users, such as user names, user locations, user jobs, user demographics, user email addresses, user phone numbers, user pictures, or the like. User data 132 may be stored or accessible in such a way that user data 132 is always tied to a respective user. Post data 134 may include virtual content created or otherwise posted by one or more users and consumable by one or more other users (e.g., users other than the one or more users that created or posted the virtual content). For example, the virtual content may be text, audio, video, or the like, and it may be privately or publicly sent or posted to one or more other users of a social media network.

Controller 110 may access user data 132 and post data 134 of social media databases 130 over network 120. In some examples, controller 110 may only gather publicly available social media data. In other examples, controller 110 may additionally gain access to at least some private data (e.g., data that is only accessible to a finite set of users of the social media service) of a user in response to the user granting permission for controller 110 to access this private social media data. For example, controller 110 may access a series of direct messages between users Bill Smith and David Santana that are not otherwise accessible to a member of the public when looking at Bill Smith's profile or posts and/or David Santana's profile or posts.

Controller 110 may mine social media networks in response to a triggering event. The triggering event may relate to one or more products. For example, the triggering event may be a sale of the one or more products to a customer, a pre-sale inquiry (e.g., an email or submitted form) related to the one or more products, a post-sale action (e.g., a mailing of the finalized agreement) for the one or more products, or the like.

The one or more products may be financial products of a financial institution, like mortgages or credit cards of a bank. Controller 110 may detect the triggering event on one or more databases as accessed over network 120. For example, controller 110 may access a private transactional database 140A of a bank to detect a sale of a financial product to a customer. Alternatively, controller 110 may access a public transactional database 140B to detect a sale of a financial product.

Controller 110 may identify an event as a triggering event by monitoring external databases for one of a predetermined list of key words or for records that include one of a predetermined set of flags. For example, controller 110 may search internal transactional database 140A or public transactional database 140B for new records that contain a “sale” term or flag as well as a “credit card” term or flag while also relating to a single customer and a business of controller 110. In some examples, controller 110 may also detect or identify that a customer of the triggering event has a social media network as part of the triggering event. For example, the triggering event may include a term or a flag that identifies the customer as managing a social media event (e.g., a customer may have filled in a “social media user” box in a form as part of the sale). For another example, controller 110 may autonomously check for social media networks of customers for every detected sale event regarding products of a business, thus categorizing (and detecting) a sale event of a customer that manages a social media as a triggering event.

In response to detecting the triggering event relating to a customer, controller 110 may mine one or more social media networks of the customer. In some examples, rather than identifying social media networks of the customer as part of the triggering event, controller 110 may identify one or more social media networks of the customer in response to the triggering event. Controller 110 may identify social media networks of the customer by matching identifying information of the triggering event with identifying information of user data 132 of the social media network. For example, controller 110 may match a name and address of a customer as identified in a sale of a triggering event with a name and address of a social media service user as indicated by user data 132.

As discussed above, the triggering event may include a flag indicating the customer as being related to a social media network. For example, the customer may complete a form requesting a mortgage quote, and as part of the mortgage form the customer may indicate that the customer manages one or more social media networks that the customer is willing to leverage for incentives. The flag may include identifying information for the customer's social media network, such as a handle that the customer uses for the customer's social media networks.

Upon identifying one or more social media networks of a customer, controller 110 may horizontally traverse the social media networks to gather social media data from the social media networks. Horizontally traversing the social media networks may include gathering social media data such as user data 132 from one or more sets of users that are connected to the customer within the respective social media network(s) of the customer. In some examples, each set of users relates to a single social media network. Some entities may be represented in more than one social media network and therefore more than one set of users. For example, a customer Bill Smith may maintain a social media network on Facebook and Instagram, and Bill Smith may be connected to user Anne Johnson in both social media networks, such that Anne Johnson is in both a first set of users of Bill's Facebook social media network and a second set of users of Bill's Instagram social media network.

Controller 110 may also gather post data 134 of users of the aforementioned sets of users. Post data 134 may include messages (e.g., tweets, direct messages, tags) sent between users and/or sent between users and the customer. Post data 134 may also include virtual interactions between users and/or between users and the customer. Virtual interactions may include “liking,” favoriting, forwarding, or commenting on messages. In some examples, virtual interactions may include viewing messages.

In some examples, controller 110 may only gather user data 132 and post data 134 (collectively referred to herein as social media data) on users that are directly connected to the customer, while in other examples controller 110 may additionally gather data from users that are two or more degrees of separation away from the customer. Put differently, in addition to gathering data of a first set of users that are directly connected to the customer, controller 110 may gather data of additional sets of users that are connected to one or more of the first set of users but are not directly connected to the customer, after which controller 110 may gather data of users that are connected to the additional sets of users (e.g., users that are three degrees of separation from the customer), etc. In this way, controller 110 may vertically traverse the social media network of the customer. For example, Bill Smith may have a social network in which Bill is connected to users Anne Johnson and David Santana, and Anne Johnson may maintain a social media network in which Anne is connected to users Steve Franklin and Laura Miller (in addition to Bill Smith) while David Santana maintains a social media network in which David is connected to users Steve Franklin and Meredith Thompson. In this example, controller 110 may gather social media data including a first set of users (Anne Johnson and David Santana) of the customer's social media network as well as a second and third set of users (Steve Franklin, Laura Miller, and Meredith Thompson) that are two degrees of separation away from the customer yet connected to users of the first set of users (and not connected to the customer). In some examples, controller 110 may gather data from users within a predetermined number of degrees of separation from the customer. Controller 110 may gather social media data from any number of degrees of separation from customer when gathering social media data.

Controller 110 may identify a subset of users that satisfy a correlation threshold with the one or more products of the triggering event and/or satisfy an association threshold with the customer. Controller 110 may use user data 132 and/or post data 134 to identify the subset of users. In some examples controller 110 may gather and use transactional data of external databases to identify the subset of users. The subset of users may be users from the gathered sets of users.

The correlation threshold may indicate an interest of a user in a product of the one or more products. Controller 110 may identify this interest in the one or more products through user data 132, post data 134, or transactional data (e.g., from private transactional database 140A or public transactional database 140B) of a user that correlates with the one or more product. Controller 110 may use natural language processing (NLP) to analyze user data 132 and post data 134 and determine whether user data 132 and post data 134 correlates with the one or more products. For example, if the one or more products include investment packages and auto loan and user data 132 and/or post data 134 of a user relates to managing wealth or new cars, the user may satisfy the correlation threshold to both of the products. Controller 110 may determine a detected correlation as being higher or lower based on how recently the relevant user data 132 or post data 134 was created, the amount of relevant user data 132 or post data 134, the tone of user data 132 or post data 134 (e.g., where user data 132 or post data 134 that indicated relatively more excitement about the one or more product may indicate a higher correlation), or the like.

Controller 110 may build a profile of a user in order to determine if the user correlates with one or more products. Controller 110 may build a profile from user data 132, post data 134, and spending data (e.g., as identified and gathered from public transactional databases 140B), and compare the profile to stored buying behavior to identify a correlation between users and products. For example, controller 110 may identify demographic information (e.g., age, nationality, gender, etc.), location information (e.g., a home state or city or address), purchase records (e.g., public records of purchases within blockchain databases that can be matched to identifying information of respective user) to build a spending profile of the user. A spending profile may be a set of data created by controller 110 that quantifies characteristics of a user. Each spending profile created/compiled by controller 110 may be unique to a user profile.

Controller 110 may match spending profiles to products, comparing spending profiles to characteristics of the products. For example, controller 110 may identify that a spending profile includes predominantly credit card transactions with a threshold number of purchases made using credit card reward points, therein matching the spending profile to a credit card reward product. Further, controller 110 may compare the spending profile of the user to data of previous sales of the products from private or public transactional database 140A, 140B to identify a correlation to the products. When a spending profile has a relatively high similarity to a percentage of users of the private and/or public transactional database 140A, 140B, controller 110 may determine that the respective user satisfies a correlation threshold with the one or more products.

Controller 110 may determine if the customer satisfies an association threshold with the user. The association threshold may indicate an amount of influence that one user (e.g., the customer) has with other users (e.g., users of the subset of users). Controller 110 may identify this influence using user data 132 or post data 134. For example, controller 110 may determine that the customer may have an amount of influence with a user as a result of user data 132 indicating a relationship between the customer and the user (e.g., a romantic, familial, education, or employment relationship). For another example, controller 110 may determine that customer may have an amount of influence with a user as a result of post data 134 that indicates an amount of communication that surpasses a frequency (e.g., such that the customer and user communicate relatively regularly) or post data 134 that indicates respect (e.g., as a result of the user regularly liking, favoriting, forwarding/retweeting, or commenting on the customer's posts).

In some examples, where a certain user is present in more than one social media service and satisfies the association threshold and/or correlation threshold in both social media services, controller 110 may identify the social media service in which the user has a relatively higher association threshold and/or correlation threshold. For example, customer Bill Smith may be connected to user Anne Johnson on both Facebook and Instagram, and Bill and Anne may regularly interact on both, but Anne may be relatively more active or consistent in positively interacting with Bill on Facebook. Controller 110 may detect this increased positivity (e.g., as indicated by a higher percentage of “likes” on Bill's posts on Facebook in comparison to Bill's posts on Instagram) and thus add Anne to a subset of users in Instagram (e.g., and not Facebook).

Controller 110 may compile all the users that satisfy the association threshold and/or correlation threshold into a subset of users. In some examples, controller 110 may present the subset of users to the customer. Controller 110 may present the subset of users to the customer so that the customer may send a social media message with the subset of users. The social media message may relate to the one or more products, such as an advertisement for the one or more products. The social media message may be direct, personalized, and private messages to individual users of the subset of users, a public message to all users of the subset of users, or some combination of the two.

In some examples, controller 110 may select a subset of users when some users of the subset satisfy the association threshold with the customer but not satisfy the correlation threshold with the one or more products. Similarly, in some examples controller 110 may select some users to the subset of users when the respective users satisfy the correlation threshold but not the association threshold. Controller 110 may determine that users satisfy the association threshold where a user has a relatively low association with the customer in response to the users simultaneously have a correspondingly relatively high association with the one or more products, or vice versa. Alternatively, in some examples, controller 110 may only select users within the subset of users when the users satisfy both the association threshold and the correlation threshold.

The business that sells the one or more products may offer an incentive to the customer in exchange for the customer communicating with the subset of users regarding the one or more products. In some examples, the business may offer the incentive using controller 110. In certain examples, controller 110 may be configured to automatically and autonomously offer the incentive to the customer in response to various detected events as described herein.

The incentive may be financial, such as cash or credit or a discount on the one or more products. The incentive may also include increased or improved features or functionalities of the one or more products, such as a better rate, access to a robo-advisor, increased coverage, or the like. In some example, the incentive may be proportional to the quantity of users within the subset and/or the “quality” of the subset of users as quantified by controller 110. For example, controller 110 may quantify the users based on the degree to which the users satisfied the association threshold and/or correlation threshold. The incentive may be dependent upon the customer sending the social media message to a user, dependent upon the user buying the product (or an equivalent) relatively soon after the social media message, or some combination thereof. For example, controller 110 may request that the customer send a message to a user, communicating that the customer may receive a 5% reduction in fees upon the transmittal of a message and an additional 10% reduction in fees upon the user purchasing the product.

In certain examples, controller 110 may create and tailor a message for the customer to send to users of the subset of users regarding the one or more products. For example, where the customer regularly interacts with the user such that there is an identifiable set of slang, nicknames, grammatical idiosyncrasies (e.g., a relatively high use of exclamation points or a lack of capitalization) or the like, controller 110 may detect these affectations and auto-populate a social media message that includes them, both to increase the ease of customer communicating with the respective user as well as potentially increasing the efficacy of the received social media message. In such examples, controller 110 may provide the tailored message for the customer in such a way that the customer may accept the offer and then send the tailored message to the user(s) in one or relatively few clicks/computer operations.

Controller 110 may implant a token in the social media message in order to track the social media message. For example, the token may be a relatively unique alphanumeric combination within the social media message, or the token may be a relatively unique combination of words within the social media message. Alternatively, the token may be a flag or tag or the like that is not visible to the customer or users on their respective user interfaces when sending or receiving or consuming the social media message, but instead is embedded within the code of the social media message. For example, controller 110 may work with a respective social media service such that, when customer is offered the incentive, any subsequent social media messages sent by the customer related to the one or more products has the token embedded in a non-public manner that is detectable by controller 110.

Controller 110 may detect when the customer sends the social media message. In some examples (e.g., where social media message is sent privately), controller 110 may use log-in information of the customer to detect the social media message. For example, the customer may use customer device 150 to send the social media message. Customer device 150 may be a computing device such as a smart phone, laptop computer, desktop computer, or the like. The customer may use app instance 152 on customer device 150 to send the social media message. App instance 152 may be a local (e.g., local to customer device 150) instance of the social media service on which the customer may log in and use the social media service. Controller 110 may gain permission (e.g., permission from the customer) to access app instance 152 and detect the social media message between the customer and the subset of users regarding the one or more products.

Controller 110 may record the transmission of the social media message within tracking database 160 using blockchain technology. For example, controller 110 may record the social media message as an instantiation event between the customer and the respective user. In other examples, controller 110 may record the triggering event as the instantiating event that results in the social media message. Controller 110 may store the social media message as a single “block” in the blockchain database, such that subsequent activity (e.g., comments on the social media messages, forwarding of social media messages, inquiries with the business resulting from social media message, sales of the products resulting from the social media message) is stored as subsequent blocks linked to the social media message within tracking database 160. In this way controller 110 may reliably store tracking data in such a way that the causal reaction to a social media message is securely stored for later reference.

For example, after the social media message is sent, controller 110 may detect interaction on the social media service related to the social media message. For example, controller 110 may detect that the social media message has been “liked” by five people, forwarded to two other people, and commented on by six people. Controller 110 may record each of these events (e.g., the likes, forwards, and comments) within tracking database 160 as connecting and branching out from the social media message, where each event is a new block in the blockchain framework. In some examples, controller 110 may further store a block for each user that viewed the social media message or was in a social media network in which the social media message was publicly posted or the like. Controller 110 may record each of these blocks with identifying information such as the user involved, the nature of the interaction, and the date and time of the interaction.

Controller 110 may detect sales of the products or inquiries related to the products by one or more users. For example, controller 110 may detect (e.g., using private or public transactional database 140A, 140B as described herein) that a user that originally received the social media message bought the one or more products from the business, while a user that commented on the social media message inquired about the one or more products from the business (e.g., by clicking on a link within the social media message or by filing out a form related to the one or more products), while a user that forwarded the social media message bought a competitor's version of the one or more products. Controller 110 may record each of these results (sale of product, inquiry, sale of competitor's product) in tracking database 160 as a new block connected to the social media message block. In some examples, controller 110 may store these results in different manners to better reflect the varying nature of the result (e.g., with a particular flag reflecting a sale or inquiry) to better organize tracking database 160.

After detecting the social media message to the subset of users, controller 110 may track the social media message. Tracking the social media message may include storing identifying information of the users that received the social media message and comparing the identifying information of the users against financial transactions from private transactional databases 140A and/or blockchain databases 140B. The identifying information may include user data 132 such as names, physical addresses, email addresses, phone numbers, or the like.

As described herein, controller 110 may use private or public transactional databases 140A, 140B to detect a sale or inquiry of the one or more products. For example, controller 110 may compare identifying user data 132 of users of tracking database 160 (which is to say, all users that the controller 110 has detected having exposure to the social media message) to financial transactions from financial databases to detect a sale of the one or more products by a user of the subset of users. For example, controller 110 may access public transactional database 140B to search for records (e.g., blocks of a bitcoin blockchain database) that include both identifying user data 132 of a user of tracking database 160 connected to the respective social media message and the one or more products. Alternatively, controller 110 may access an internal transactional database 140A (e.g., a private transactional database 140A of the financial institution that sells the one or more products) and detect a sale as recorded within the internal financial database that relates to both a user of the subset of users (e.g., as recorded in tracking database 160) and a product of the one or more products. As discussed above, controller 110 may detect and store within tracking database 160 a “partial positive” of a sale of a competing product between a user and a competitor of the financial institution (e.g., as the customer successfully influenced the user to buy the type of product of the message, if not the particular product of the message).

As discussed herein, controller 110 may send to the customer, on behalf of the business, an offer of an incentive that would be provided in response to the detection of a sale involving the one or more products and users of the subset of users (or users that interacted with the social media message for the subset of users). The incentive may be a financial incentive or a feature incentive as discussed herein. Controller 110, on behalf of the business, may send the incentive to the customer in response to detecting the sale in addition to or in lieu of offering an incentive in return for the customer communicating with the subset of users. For example, in response to detecting that the customer has purchased one or more products (e.g., using private or public transactional databases 140A, 140B) and determining a subset of users that satisfy a correlation threshold and/or association threshold (e.g., using user data 132 and post data 134 of social media database 130), controller 110 may send an offer to the customer of an incentive if the customer sends a message to the subset of users regarding the one or more products that results in a sale. Controller 110 may then detect the message between the customer and the subset of users followed by a sale involving the one or more products and a user of the subset of user (e.g., as detected using private or public transactional databases 140A, 140B and recorded in tracking database 160), in response to which controller 110 may provide the incentive to the customer.

In some examples, controller 110 may modify the offered incentives over time in response to determined trends in the customer's messages success (or lack thereof) in converting messages into sales. For example, after referencing tracking database 160, controller 110 may determine that customer has a high rate of messages resulting in sales, and may therein provide a relatively higher or otherwise better incentive, or provide incentives upon sending messages (e.g., rather than waiting for a successful sale resulting from the message to offer an incentive). Conversely, controller 110 may reference tracking database 160 and determine to provide a relatively worse incentive to customers that controller 110 determines have a relatively poor rate of converting messages into sales. Controller 110 may determine a track record of the customer over an extended period of duration (e.g., weeks, months, or years) as recorded in tracking database 160 and in response to a plurality of sent messages. In some examples, controller 110 may determine whether to increase or decrease incentives in response to identifying if the customer satisfies or fails a set of predetermined thresholds (e.g., converting at least 25% of messages into sales over a one-year period). In other examples, controller 110 may determine whether to increase or decrease incentives in response to determining a relative success rate compared to other comparable users (e.g., if customer is in the 50^{th} percentile among users in her age group in converting messages to sales).

In some examples, controller 110 may determine a subset of users that satisfy a correlation threshold with one or more products of the customer, rather than one or more products of the triggering event or products of a business that the customer is engaging with. For example, a small business customer may approach a bank for a loan. The bank may use controller 110 to analyze the social media network of the customer and identify a subset of customers that relate to one or more products. The one or more products may be products of the small business customer (e.g., rather than the bank). For example, controller 110 may detect that the small business customer sells the one or more products when the small business customer approaches the bank, in response to which controller 110 may gather social media data related to users connected to the customer (e.g., connected within a predetermined number of degrees of separation), in response to which controller may identify the subset of customers that satisfy both the association threshold with the customer and the correlation threshold with the one or more products of the customer. In this case, rather than offering an incentive to the customer, controller 110 may offer the subset of users to the customer as a service (e.g., a service that is bundled with the loan for which the customer initially engaged with the bank, or a standalone service for which the customer pays a separate fee). Controller 110 may autonomously and automatically determine the subset of users in response to the customer initiating engagement with the bank (e.g., such that controller 110 identifies the subset of users within a minute or two of the customer providing identifying information to the bank), such that the bank may provide or otherwise discuss the subset of users with the customer during the initial interaction with the customer.

In this way, the system may enable a business to better determine groups of people who can consume or promote products of the business using social media networks. Further, the system may improve an ability of a business to set appropriate incentives for customers in response for these customers promoting products based on the social media networks that the customers maintain and the results of the customers in promoting products.

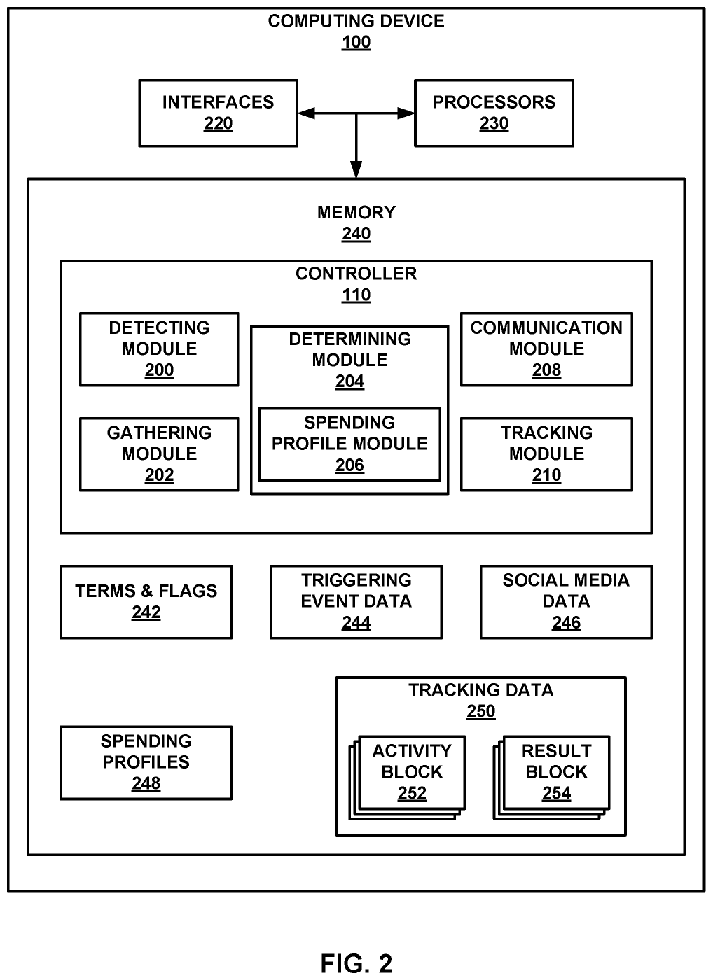

FIG. 2 is a block diagram illustrating an example computing device 100 for mining social media networks, in accordance with the techniques of this disclosure. As illustrated in FIG. 2, computing device 100 includes controller 110, interfaces 220, processors 230, and memory 240. Each of the components, units or modules of computing device 100 are coupled (physically, communicatively, and/or operatively) using communication channels for inter-component communications. In some examples, the communication channels may include a system bus, a network connection, an inter-process communication data structure, or any other method for communicating data.

Computing device 100 may include one or more interfaces 102 for allowing controller 110 to communicate with one or more databases (e.g., social media database 130, private transactional database 140A or public transactional database 140B), devices, and/or one or more networks 120. In some examples, the interfaces 220 and or controller 110 may include a service data objects framework to ensure that logic modules within are accessed in a uniform way and access external modules/data/components in a uniform way. Interfaces 220 may include one or more network interface cards, such as Ethernet cards, and/or any other types of interface devices that can send and receive information. In some examples, controller 110 may utilize interfaces 220 to communicate with devices of a network 120, such as databases, third-party servers, financial-network servers, and/or any other suitable device. For example, controller 110 may utilize interfaces 220 to communicate with social media databases 130 or other external databases, and customer devices 150 of FIG. 1 as described herein. Any suitable number of interfaces may be used to perform the described functions according to particular needs.

Computing device 100 may include one or more processors 230 configured to implement functionality and/or process instructions for execution within computing device 100. For example, processors 230 may be capable of processing instructions stored by memory 240. Processors 230 may include, for example, microprocessors, digital signal processors (DSPs), application specific integrated circuits (ASICs), field-programmable gate arrays (FPGAs), and/or equivalent discrete or integrated logic circuitry.

Computing device 100 may include memory 240 configured to store information within computing device 100. Memory 240 may include a computer-readable storage medium or computer-readable storage device. In some examples, memory 240 may include one or more of a short-term memory or a long-term memory. Memory 240 may include, for example, random access memories (RAM), dynamic random access memories (DRAM), static random access memories (SRAM), magnetic hard discs, optical discs, floppy discs, flash memories, or forms of electrically programmable memories (EPROM), or electrically erasable and programmable memories (EEPROM). In some examples, memory 240 may store logic (e.g., logic of controller 110 as contained within numerous modules as depicted in FIG. 2) for execution by one or more processors 230. In further examples, memory 240 may be used by controller 110 to temporarily store information during program execution, or to pseudo-permanently store data for controller 110. For example, memory 240 may store threshold levels, predetermined tags or flags for triggering events, spending profile parameters, or the like.

Controller 110 may include instructions to be executed by one or more processors 230 of computing device 100 to perform the functions of controller 110 as described herein. Controller 110 may “mine” (e.g., navigate within, gather from, analyze, store in a reliable format causal data from, and eventually select from) social media service databases 130. Examples of social media services may include Facebook, Twitter, Instagram, LinkedIn, or the like. Controller 110 may mine social media databases 130 to determine groups of users that are correlated with one or more products. Controller 110 may mine social media databases 130 in response to a triggering event related to a customer. Controller 110 may include one or more modules to mine social media networks, such as detecting module 200, gathering module 202, determining module 204, communication module 208, and tracking module 210. In some cases, controller 110 may include more or less modules, or similar modules executing different or overlapping functions.

The customer may manage/maintain a social media network on one or more social media services in which the customer virtually connects to and interacts with a set of users. Detecting module 200 of controller 110 may detect a triggering event. Detecting module 200 may analyze data of one or more data sources to detect a triggering event. The data sources may be within computing device 100 (e.g., saved to memory 240) or the data sources may be external to computing device 100, such that detecting module 200 utilizes interfaces 220 to access the data sources. For example, the data sources may include internal transactional database 140A that detecting module 200 accesses over network 120. Detecting module 200 may compare data of the one or more databases against a set of one or more predetermined terms or flags that indicate a triggering event. The predetermined terms or flags may be stored in memory 240 as terms and flags 242. Terms 242 may include words like “sale,” “purchase,” “inquiry,” “transaction,” “bill,” or the like, and flags 242 may indicate the same. Detecting module 200 may analyze new entries to the one or more databases to detect the triggering event.

In other examples, detecting module 200 may detect triggering event using public transactional database 140B as a data source. For example, detecting module 200 may identify and analyze a new entry “WILLIAM SMITH MORTGAGE SALE” in public transactional database 140B and may identify that SALE matches term 242 “sale,” customer WILLIAM SMITH matches user “Bill Smith,” and MORTGAGE matches product “mortgage.” From this, detecting module 200 may detect a triggering event relating to the customer Bill Smith purchasing product “mortgage” of the one or more products. For another example, detecting module 200 may identify and analyze a new entry “ANNE JOHNSON INQUERY CAR LOAN” in internal transactional database 140A and may therein detect a triggering event relating to a customer Anne Johnson inquiring about a car loan product.

In response to detecting module 200 detecting a triggering event, gathering module 202 may gather social media data. Detecting module 200 may sent a prompt to gathering module 202 related to the triggering event. The prompt may include data of the triggering event (e.g., identifying information of the customer and product(s)). In some examples, detecting module 200 may store data of the triggering event (e.g., store within memory 240 as triggering event data 242) for the use of gathering module 202 or other modules. Gathering module 202 may navigate through and gathering data from one or more social media databases 130. For example, where each social media service effectively maintains one social media database 130 (e.g., such that social media database 130 is the publicly available user data 132 and post data 134 hosted by the respective social media service that is available on the internet), gathering module 202 may navigate through one social media database 130 for each different social media service used by the customer.

As discussed herein, gathering module 202 may gather user data 132 and post data 134 from social media databases 130. Gathering module 202 may gather user data 132 and post data 134 by navigating to the customer's profile or handle and gathering post data 134 from the customer's profile or handle. Gathering module 202 gathering post data 134 may include identifying and recording media (e.g., text, video, audio, or the like) that is posted by the customer and/or to the customer, as well as gathering any interactions (e.g., likes, favorites, comments, emoticons, or the like) between the customer and users that is related to the media. Gathering module 202 may also identify a set of users that are connected to the customer (e.g., via a friend list or a followers list or the like) and navigate to respective profiles or handles of these users. Once gathering module 202 navigates to respective user profiles or handles, gathering module 202 may gather user data 132 and post data 134 from these profiles or handles as described herein. In this way gathering module 202 may navigate through and gather social media data from the social media network of the customer. In some examples, in addition to horizontally navigating through and gathering data from users connected to the customer within the social media network of the customer, gathering module 200 may vertically traverse through the social media service by gathering social media data of social media networks of the users that are separated by two or more degree of separation from the customer of the social media service (e.g., such that the gathering module 202 navigates to and gathers data from users that are not themselves directly connected to the customer but are connected to at least one user that is directly connected to the customer). Gathering module 202 may store the gathered data in memory 240 as social media data 246. Gathering module 202 may store social media data 246 either temporarily or permanently for use by determining module 204 or other modules.

Determining module 204 may use social media data 246 as gathered by gathering module 204 to determine a subset of users that satisfy a correlation threshold and association threshold as described herein. In some examples, gathering module 202 may send a prompt to determining module 204 indicating the presence of the gathered social media data. For example, detecting module 200 may detect (and therein store as triggering event data 244) that the triggering event related to mortgage refinancing products, in response to which gathering module 202 may gather (and store as social media data 246) post data 134 indicating that a user has made posts relating to mortgages or refinancing or the like. Using this triggering event data 244 and social media data 246, determining module 204 may determine that the user has satisfied a correlation threshold with the mortgage refinancing product.

Determining module 204 may determine that social media data 246 of a user satisfies a correlation threshold with the one more products using NLP techniques. Determining module 204 may use NLP techniques to identify a subject and a sentiment of social media data. For example, determining module 204 may identify that social media data 246 of a user relates to a subject of the product (e.g., the user posted about mortgage costs when the product is mortgage financing) and may further identify a sentiment of social media data 246 related to the subject (e.g., the user posted that mortgage costs were too high). Determining module 204 may identify that a subject of some of a portion of social media data 246 is correlated to the product and/or that a sentiment of some social media data 246 identifies a positive attitude or belief regarding the product. In response to identifying this positive, determining module 204 may identify that the user satisfies a correlation threshold with the product(s).

Determining module 204 may further identify users that satisfy an association threshold with the customer. Determining module 204 may use user data 132 and/or post data 134 to determine that one or more users (e.g., users of the subset of users) satisfy the association threshold. For example, determining module 204 may determine that users have at least a threshold number of interactions on the social media service with the customer (e.g., mutual “likes” of respective virtual posts of the user and/or customer, messages sent back and forth between the user and customer, tags of the user or customer within posts on the social media service made by the customer or user, etc.). In some examples, determining module 204 may determine a subset of users that satisfies both the correlation threshold with the one or more products and the association threshold with the customer.

In some examples, determining module 204 includes spending profile module 206. Spending profile module 206 may determine a spending profile of the user that quantifies spending characteristics and/or purchasing power of a user. Spending profile module 206 may create a spending profile using user data 132, post data 134, and/or historical purchase data from private and/or public transactional database 140A, 140B. Spending module 206 may save any created spending profiles within memory 240 as spending profiles 248. Spending profile 248 may include such information as previous purchases, wage, age, profession, employment status, geographic location, or the like. Each spending profile 248 created/compiled by spending profile module 206 may relate to and be unique to a single user profile.

Determining module 204 may use spending profiles 248 created by spending profile module 206 to determine if users correlate to products. For example, determining module 204 may compare spending profiles 248 to products, and/or determining module 204 may compare determined spending profiles 248 of the users to (determined or historical) spending profiles of previous purchasers of the products. For example, determining module 204 may determine that respective spending profiles 248 created by spending profile module 206 for respective users matches a typical spending profile for the product, such that the user satisfies the correlation threshold for the product. For another example, spending profile module 206 may create and save respective spending profiles 248 that identify that a user predominantly employs credit cards “reward” points to pay for transactions at a rate that satisfies a threshold frequency, and determining module 204 may use this characteristic to identify that this user has a correlation to a credit card reward product. Other uses by determining module 204 of respective spending profiles 248 determined by spending profile module 206 are also possible.

In response to determining module 204 identifying the subset of users, the customer may communicate with the subset of users regarding the one or more products. The customer may communicate with the subset of users in response for an incentive from the organization. Communication module 208 may offer the incentive to the customer on behalf of the business (e.g., such that the business controls and/or authorizes communication module 208 offering the incentive to the customer). In some examples, the incentive may be offered in exchange for a sale or positive interaction between the user and the organization that results from the social media message (e.g., such that the customer would get the incentive once the user bought the product or otherwise inquired about the product). In other examples, the incentive may be offered in exchange for the social media message (e.g., such that the incentive is given to the customer immediately upon the customer communicating with the respective user).

The incentive may be proportional to the number of users within the subset of users that purchase products of the one or more products. Alternatively, or additionally, the incentive may be proportional to the correlation between the user and the products or the incentive may be proportional to the association between the user and the customer (e.g., as a relatively higher correlation or association may indicate a higher chance of sale, therein increasing the value of the message to the business providing the incentive). In some examples, communication module 208 may calculate what the incentive is or might be (e.g., where the incentive is based on future actions and therefore is currently unquantified) and send these calculated incentive details to the customer within the offer.

In some examples, communication module 208 may prompt the customer to create and send the message. In other examples, communication module 208 may create the message for the customer and prompt the customer to send the created message. Communication module 208 may create the message using social media data gathered by gathering module 202 as well as subject and/or sentiment data identified by determining module 204. For example, communication module 208 may create a message for the user that mimics the tone and colloquialisms used by the customer and/or user and specifically addresses a relevant sentiment about the product that was previously expressed by the user.

Once the customer sends the social media message to the user, tracking module 210 may track a message from the customer to users of the subset of users. Tracking module 210 may track the message through social media network, identifying and analyzing social media actions relating to the message (e.g., likes of the message, favorites of the message, forwards of the message, etc.). Tracking module 210 may record relevant tracking data 250 in memory 240. The data of tracking data 250 may be equivalent to the data of tracking database 160 of FIG. 1, though tracking data 250 is depicted as within memory 240 (rather than externally within tracking database 160) for illustration purposes. It is to be understood that in some examples tracking data 250 may be stored physically externally to computing device 100, such as in a server or memory device that is connected to or otherwise accessible by computing device 100.

Tracking module 210 may record tracking data 250 (e.g., social media messages, forwards, views, likes, clicking on links). Tracking module 210 may record tracking data 250 using blockchain technology, such that each record of activity is stored as a new activity block 252 that is correlated to the causal activity block 252 that preceded it. For example, within tracking data 250, tracking module 210 may record as subsequent blocks some triggering event data 244, a social media message, and resulting social interactions related to the social media message.

Tracking module 210 may match purchases of similar or identical products to the message. For example, using data from private transactional database 140A or public transactional database 140B, tracking module 210 may determine that a user of the subset of users that received a message relating to a product later purchased the exact product or a substantially similar product. For another example, tracking module 210 may determine that a “downstream” user that was forwarded and then favorited a message relating to a product then purchased the product. Tracking module 210 may record such sales, inquiries, or interactions between users and the business within tracking data 250 as result blocks 254. In some examples, tracking module 210 may track a message and determine that a forwarded message, once favorited or reposted or retweeted or the like by a downstream user, resulted in a relatively high number of sales of a product of the message. Tracking module 210 may record within memory 240 as tracking data 250 each of these favorites and reposts and retweets as activity blocks 252, and may save within tracking data each of sales as respective result blocks 254.

Using this data, in response to a future triggering event, determining module 204 may identify the downstream user as a relatively influential user based on the previous success of the downstream user as captured by tracking module 210. In subsequent actions, tracking module 210 may prioritize communicating directly with the identified downstream influential user when offering incentives in response for communication with a subset of users. By tracking messages within analyzed social media networks and identifying influential users, tracking module 210 may enable controller 110 to improve at identifying and communicating with subsets of users that satisfy correlation thresholds and/or association thresholds over time, such that controller 110 may increasingly record social media messages result in sales.

Similarly, as tracking data 250 tracking module 210 records result blocks 254 that by certain users of certain products, tracking module 210 may flag these users as interested in this class of products. Determining module 204 may prioritize sending these users social media messages regarding similar products in the future (e.g., by using relatively better incentives when asking a customer to communicate with these users). Along the same lines, tracking module 210 identify over time and flag users that do not regularly purchase products, even when these users have a relatively high correlation with the products and a relatively high association with the communicating party. Determining module 204 may use this data from tracking module 20 to deprioritize sending these users future communication regarding similar products. In this way, determining module 204 may use tracking data 250 as stored by tracking module to improve at determining subsets of users. For example, determining module 204 or communication module 208 may modify an incentive based on this tracking data 250, increasing the incentive when the respective module identifies strong “track record” of social media messages resulting in purchases, and lowering (or making more conditional) an incentive when a weak track record is identified.

In some examples, tracking module 210 may track messages with a token embedded in the social media message as described herein. Communication module 208 may create the social media message for customer to send to user with a token that includes unique text that tracking module 210 may track. For example, communication module 208 may create a social media message that includes a token of a relatively unique alphanumeric array of text, a relatively unique arrangement of words, or an identifier embedded (e.g., hidden from a user viewing the social media message on the standard social media service user interface) within the code or formatting of the social media message. Tracking module 210 and/or communication module 208 may store this token in tracking data 250.

Alternatively, or additionally, the token may include a hyperlink in the social media message. For example, the link may be a link related to the one or more product. A user clicking on the link may be trackable by tracking module 210. For example, the link may route the user to a webpage of the business or organization that sells the one or more products (and manages computing device 100) such that the routing execution includes metadata on the link, user, and/or social media message. The metadata may be provided to tracking module 210 and therein stored within tracking data 250 as activity blocks 252.

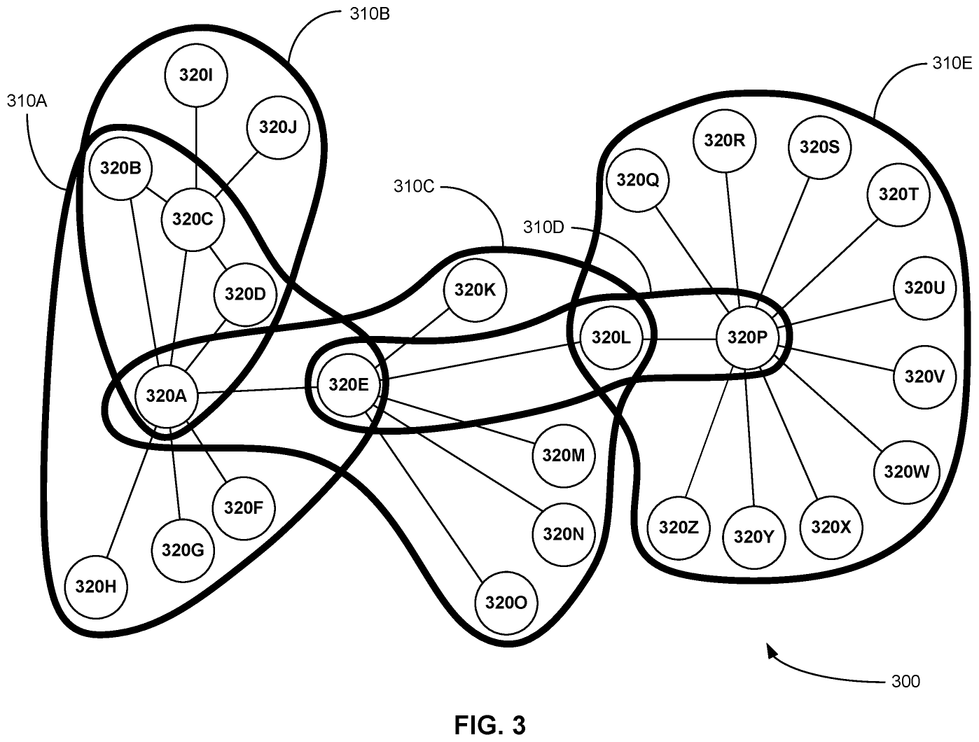

FIG. 3 is a conceptual diagram depicting a plurality of social medial networks 310A-310E (collectively “social media networks 310”) of social media service 300. Social media networks 310 may include users 320A-320Z (collectively “users 320”). Specifically, social media network 310A includes 320A-H, social media network 310B includes users 320A-D, 3201, and 3201, social media network 310C includes users 320A, 320E, and 320K-O, social media 310D includes users 320E, 320L, and 320P, and social media network 310E includes users 320L, and 320P-Z. Social media networks 310 may be managed by respective users 320 that are connected to each other respective user 320 of the respective social media network 310. For example, user 320A manages social media network 310A, user 320C manages social media network 310B, user 320E manages social media network 310C, user 320L manages social media network 310D, and user 320P manages social media network 310E. It is to be understood that the spatial arrangement of users 320 and social media networks 310 within FIG. 3 is for purposes of illustration only and is not intended to convey any particular meaning to users 320 and social media networks 310 or the relationships therebetween.

Social media networks 310, social media service 300, and users 320 may be substantially similar to the social media networks, social media services, and users described herein, with the exception of any differences explicitly described below. User 320A may be the customer. User 320A (hereinafter referred to as customer 320A) may purchase one or more products as detected by controller 110 of FIG. 1. Upon detecting this triggering event as described above, controller 110 may navigate through social media databases 130 and identify that customer 320A manages social media network 310A, within which user 310A connects to a set of users 310B-310H. Controller 110 may identify a subset of the set of users 310B-310H that satisfy the correlation threshold and association threshold as described herein. For example, controller 110 may identify users 320D-G as the subset of users. Controller 110 may thus offer an incentive to customer 320A in return for customer 320A communicating with the subset of users 320D-320G as described herein.

In some examples, controller 110 may gather and analyze social media data beyond social media network 310A, whether gathering and analyzing social media data from social media networks 310 two degrees of separation (e.g., social media networks 310B and 310C), three degrees of separation (e.g., social media network 310D), three degrees of separation (e.g., social media network 310E) or more from the initiating social media network 310A of customer 320A. For example, controller 110 may gather and analyze user data 132 and post data 134 within two degrees of separation from social media network 310A of customer 320A, and thus determine a subset of users 320D, 320F, and 320K. In some examples, controller 110 may offer an incentive to customer 320A in return for customer 320A communicating with each of users 320D, 320F, and 320K (e.g., where social media service 300 was configured to allow users 320 communicate with users outside of their social media network 310). In other examples, controller 110 may determine that user 320C has a stronger association with user 320D and/or that user 320E has a stronger association with user 320K (e.g., in comparison to the association between customer 320A and users 320D, 320K), and therein offer an incentive to users 320C, 320E in return for these users to communicate with users 320D, 320K regarding the one or more products. In such examples, controller 110 may still provide a (potentially relatively smaller) incentive to customer 320A in exchange for customer 320A acting as the intermediary between controller 110 and users 320C, 320E. For example, controller 110 may provide a product discount to customer 320A in exchange for customer 320A asking users 320C, 320E to communicate with users 320D, 320K about the one or more products. Controller 110 may offer users 320C, 320E a cash incentive in return for users 320C, 320E communicating with users 320D, 320K. Controller 110 may then monitor social media service 300 for the social media message(s), in response to which controller 110 may provide an incentive to the respective communicating user(s) 320A, 320C, 320E.

In some examples, controller 110 may provide a series of (relatively smaller) incentives to a series of users 320 in order to get to a desired user that satisfies an association threshold with a user 320. For example, after detecting a sale of one or more products to customer 320A, controller 110 may gather social media data and determine spending profiles as discussed herein of users 320 within three degrees of separation of customer 320A. Controller 110 may detect that user 320T satisfies a correlation threshold with the one or more products, but only satisfies the association threshold with user 320P (e.g., such that it may be ineffective for customer 320A or other intermediary users 320 to communicate with user 320P directly). In this example, controller 110 may offer a first incentive for customer 320A to communicate with user 320E (bridging the first degree of separation), through which controller 110 may offer a second incentive for user 320E to communicate with user 320L (bridging the second degree of separation), through which controller 110 may offer a third incentive for user 320L to communicate with user 320P (bridging the third degree of separation), at which point controller 110 may offer a fourth incentive for user 320P to communicate to user 320T about the one or more products. In other examples, controller 110 may determine that customer 320A satisfies an association threshold with user 320T (e.g., as a result of a sufficiently high correlation threshold between user 320T and the one or more products) such that controller 110 requests that customer 320A communicates directly with user 320T.

Further, as discussed herein, controller 110 may track messages throughout social media service 300 to identify downstream users 320 that are particularly influential. For example, in response to a triggering event, controller 110 may request that customer 320A send a public message to users 320C-320E about a product, in response to which user 320E may purchase the product (e.g., as detected by controller 110 using public transactional database 140B) and repost a similar message about the product. Through tracking the message (e.g., using a token embedded in the social media message), controller 110 may identify similar messages being reposted by user 320L, after which a similar message may be reposted by user 320P. Once user 320P reposts message, controller 110 may identify that users 320R-320Y, all of which are connected to user 320P, purchase the product of the message or a substantially product. In response to making this determination (and analyzing the blockchain tracking database 160 populated by controller 110 that reliably stores and organizing this data), controller 110 may flag user 320P as a particularly influential user 320, therein prioritizing offering user 320P an incentive (e.g., either directly or through intermediary users 320 as described herein) in return for user 320P communicating about products. Controller 110 may prioritize user 320P by offering relatively higher/better incentives (e.g., more cash, bigger discounts, higher valued services), by offering incentives to user 320P in return for communication with a particular user 320 rather than offering a similar incentive to another user 320 in return for the other user 320 to communicate with the particular user 320, or the like.

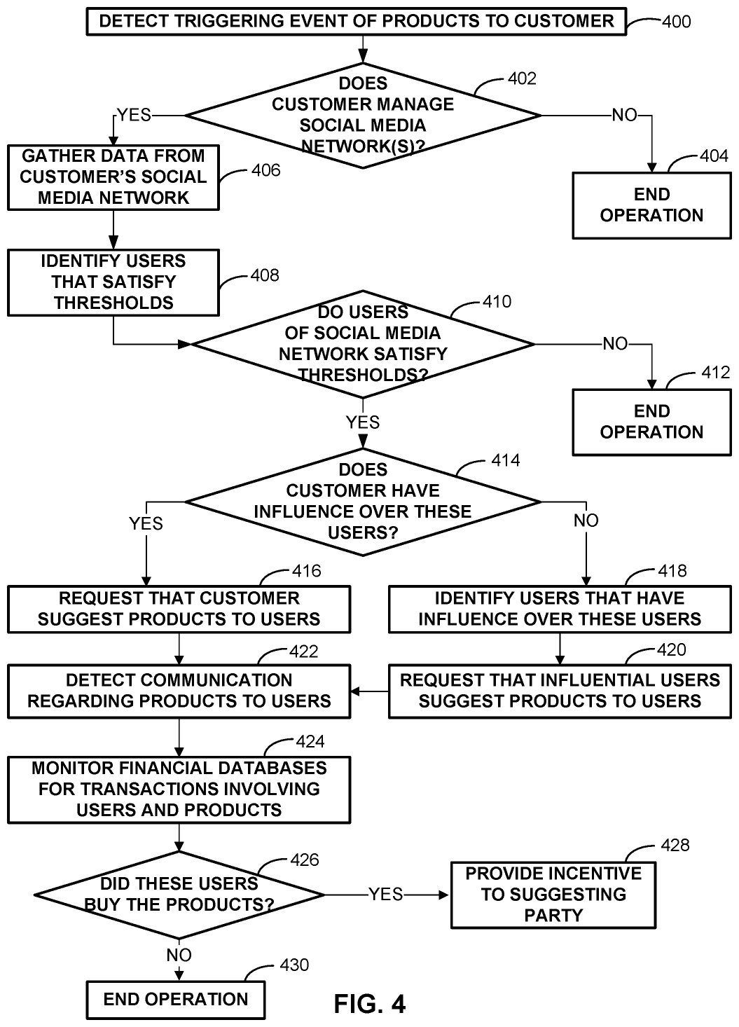

FIG. 4 depicts a flowchart illustrating an example method of mining social media networks for users to promote and/or consume products. The method may identify a finite set of unique users of the social media networks based on a potential of the finite set of unique users to consume and/or as promote one or more products. Though FIG. 4 is discussed using the system 101 of FIG. 1 and the social media service 300 of FIG. 3, it is to be understood that the methods discussed herein may include and/or utilize other systems and methods in other examples. Controller 110 may identify a triggering event related to one or more products to customer 320A (400). The products may be financial products from a financial institution. For example, a customer may approach (e.g., fill out a form of, interact with online, physically walk into) an organization (e.g., a bank) in relation to a product (e.g., a credit card). The triggering event may be a sale of the one or more products. Alternatively, the triggering event may be an event that precedes or is subsequent to a sale, such as an initial query/form submission, a transmittal of agreed-to terms of the sale (e.g., an electronic or physical mailing of the terms and conditions of the sale), a bill transmittal (e.g., a bill related to the sale), or the like.

In some examples, controller 110 autonomously (e.g., without human intervention) detects the triggering event (e.g., and then autonomously mines social media networks 310 as described herein). Controller 110 may detect triggering event by monitoring private and/or public transactional databases 140A, 140B for terms or flags that indicate the triggering event as discussed herein. For example, controller 110 may search private transactional databases 140A and/or public transactional databases 140B for records of transmittals that include terms and conditions. In other examples, the triggering event may include an authorized user “activating” controller 110 or otherwise actively commanding controller to mine social media networks 310 in accordance with the techniques disclosed herein.

Controller 110 may determine if customer 320A manages social media network(s) 310 on social media service(s) 300 (402). If controller 110 determines that customer 320A does not manage any social media networks 310, controller 110 may terminate the process of mining social media networks 310 (404). Alternatively, if controller 110 determines that customer 320A manages social media networks 310, controller 110 gathers data from customer's 320A social media networks 310 (406). The gathered data may include user data 132 and post data 134. In some examples, controller 110 may gather data from substantially every detected social media network 310 of customer 320A. In other examples, controller 110 may only gather data from some social media networks 310 from a predetermined list of social media services 300. In certain

Controller 110 may gather data from social media network 310A of customer 320A. In other examples, controller 110 may gather data from social media networks 310B, 310C that are two degrees of separation away from customer 320A, social media networks 310D that are three degrees of separation away from customer 320A, and/or social media networks 310E that are four degrees of separation away from customer 320A. The magnitude of separation from customer 320A within which controller 110 gathers data may be predetermined, such that controller 110 substantially always gathers social media networks 310 that are within the predetermined degrees of separation from customer 320A. Alternatively, controller 110 may determine a magnitude of separation from customer 320A within which to gather information based on user data 132 and post data 134 of respective social media network 320. For example, controller 110 may gather data from relatively more degrees of separation in response to determining that customer 320A has relatively more influence as discussed herein. Alternatively, controller 110 may keep gathering data from social media networks 310 of increasing degrees of separation from customer 320A until controller 110 evaluates a threshold number of users 320 or identifies a threshold number of users 320 that satisfy the correlation threshold 320 and/or association threshold as discussed herein (e.g., such that operations 408 and 410 of FIG. 4 may create a loop with operation 406 until controller 110 identifies the threshold number of users 320).

In some examples, in addition to gathering social media data from social media databases 130, controller 110 may create spending profiles of users 320 using private transactional databases 140A and/or public transactional databases 140B as described herein. Controller 110 may create spending profiles of every user 320 of the evaluated social media networks 310. Alternatively, controller 110 may create spending profiles in response to users 320 satisfying the correlation threshold with the one or more products and/or users 320 satisfying the association threshold with other users 320 of the evaluated social media networks 310.

Using the gathered user data 132 and post data 134 (and potentially the created spending profiles), controller 110 identifies a subset of users 320 that satisfy a correlation threshold with the one or more products and an association threshold with a respective user 320 of the evaluated social media networks 310 (408). Controller 110 determines that users 320 satisfy the correlation threshold with the one or more products by matching user data 132, post data 134, and or spending profiles of respective users 320 with characteristics of the one more products as discussed herein. For example, users 320 may satisfy the correlation threshold with products by posting about the products or posting content that relates to the products. For example, one of the products may be a mortgage refinancing service, and controller 110 may identify post data 134 from a respective user 320 as indicating displeasure with current mortgage payments.

Controller 110 may identify different users 320 as satisfying the correlation threshold with different products of the one or more products. For example, where a business selling the products is a financial institution, controller 110 may identify some of the unique users 320 as relating to a home loan from the bank, while controller 110 may identify one or more other unique users 320 as relating to a mutual fund product, while controller 110 may identify one or more other unique users 320 as relating to a credit card. The system may identify the unique set of users 320 based on spending needs or desires as indicated on social media networks 310 and/or determined spending profiles of respective users 320.

Controller 110 may determine if a sufficient number of users 320 satisfy the correlation threshold and association threshold (410). If controller 110 determines that no (or insufficiently few) users 320 satisfy the correlation threshold with the one or more products, controller may terminate the mining procedure relating to the customer 320A (412). If controller 110 determines that a sufficiently numerous subset of users 320 that satisfy the correlation threshold and association threshold, controller 110 determines if customer 320A has influence over the subset of users 320 (414). Controller 110 may determine if customer 320A has influence over the subset of users 320 by determining if the customer 320A and the subset of users 320 satisfy the association threshold.

Controller 110 may analyze user data 132 and post data 134 of customer 320A and respective users 320 of the subset of users 320 to determine if customer 320A satisfies the association threshold with the respective users 320. For example, controller 110 may identify that some users 320 have satisfied an association threshold with the customer 320A by determining that these users 320 have interacted with customer 320A more than a threshold amount, by, e.g., communicating with customer 320A more than a once per week threshold, or sending social media message s to (rather than receiving social media message from) the customer 320A at least once a week on average over the course of the previous two months. For another example, controller 110 may identify users 320 as satisfying the association threshold with customer 320A by respective users 320 “liking” or “favoriting” or otherwise positively responding to content of customer 320A more than a threshold amount (e.g., where respective users 320 positively responds to at least 10% of the content of customer 320A). For another example, controller 110 may compare post data 134 and spending profiles of customer 320A respective users 320 and identify that respective users 320 have generally similar spending needs or desires. In some examples, controller 110 may utilize natural NLP techniques to analyze and determine sentiments of posts of respective users 320 of social media networks 110.

If customer 320A does satisfy the association threshold with the subset of users 320, controller 110 may request that customer 320A communicates with the subset of users 320 regarding the one or more products (416). Alternatively, if customer 320A does not satisfy the association threshold with users 320 of the subset of users 320, controller 110 may identify the other users 320 of the social media service 300 that do satisfy the association threshold (418). Controller 110 may request that these other identified influential users 320 communicate with the subset of users 320 regarding the one or more products (420). In some examples, controller 110 may submit an offer to such influential users 320 through the customer 320A (and/or other intermediary users 320) as described herein. Controller 110 may detect that communication/social media messages are sent to users 320 of the subset of users through the social media service 300 (422). The social media messages may relate to one or more products (e.g., products of the financial institution) as described herein. The social media messages may be sent with a token embedded within the messages as described herein to enable the controller 110 to track the messages.

Once a message is sent to the subset of users 320, controller 110 monitors one or more external databases for transactions involving the users 320 and/or the one or more products (424). Monitoring external databases may include recording activity of the messages within a tracking database 160. Controller may store data regarding social media activity (e.g., forwards, favorites, likes, comments) related to the social media messages within tracking database 160. Controller may also store result data (e.g., sales, inquiries, users clicking on embedded links to access the website of the business) as identified from external databases within tracking database 160. External databases include internal transactional databases 140A and public transactional databases 140B. Controller 110 may determine if users 320 bought any products of the one or more products (426). In some examples, controller 110 may determine if users 320 bought any competing products to the one or more products using blockchain financial databases 140B. If users 320 bought one or more products, controller 110 may provide an incentive to customer 320A or the respective user 320 that communicated to the subset of users 320 (428). If controller 110 does not detect users 320 of the subset of users 320 purchasing the one or more products, controller 110 may terminate the method without offering an incentive (430). In some examples, controller 110 may wait a threshold period of time (e.g., a week or month) before terminating the method.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Techniques of this disclosure may provide one or more technical advantages. For example, certain techniques of this disclosure may, in some instances, provide a technical solution to selecting users that can promote or consume products. For example, in response to a triggering event related to a customer and one or more products, social media networks of the customer may be mined. Social media messages may be sent to identified subsets of customers, and the social media messages may be tracked to identify influential users and any sales that result from the messages. Information from social media and transactional databases may be cross-correlated to create a spending profile of the users within the social media networks of the customer. The spending profiles may be compared to the one or more products, and those spending profiles that have the highest correlation may be contacted by the customer in response for an incentive.

Various examples have been described. These and other examples are within the scope of the following claims.

1. A method comprising:
detecting, by a computing device, a first triggering event, wherein the first triggering event relates to a transaction by a customer related to one or more products, and wherein the customer manages a social media network on a social media service;
recording, by the computing device, the first triggering event in a blockchain database as one or more originating blocks;
after recording the first triggering event, gathering, by the computing device, social media data from the social media network of the customer, the social media network including a set of users that are virtually connected to the customer on the social media service, wherein the social media data relates to the set of users, and wherein the social media data includes user data that includes identifying information related to respective users of the set of users and post data that includes virtual content created by one or more users of the set of users;
determining, by the computing device and using the gathered social media data, a subset of the set of users that satisfy a correlation threshold indicating an interest in the one or more products and an association threshold indicating an influence of the customer;
presenting, by the computing device and to the customer, the subset of the set of users;
detecting, by the computing device, one or more social media messages sent to users of the subset of users by the customer using the social media service in response to the presenting of the subset of the set of users, the one or more social media messages relating to the one or more products, and the one or more social media messages each including a token that includes at least one of unique text or a hyperlink that generates routing metadata when executed;
recording, by the computing device, the one or more social media messages in the blockchain database as one or more subsequent blocks linked to the one or more blocks associated with the first triggering event;
tracking, by the computing device, one or more social media interactions of the downstream user to the one or more social media messages using the corresponding token received with the respective social media interaction;
recording, by the computing device, the one or more social media interactions in the blockchain database as one or more subsequent blocks linked to the one or more blocks associated with the one or more social media messages;
after recording the one or more social media messages, detecting, by the computing device, one or more records of sale for the one or more products and performed by the users of the subset of users in response to the one or more social media messages recorded in the blockchain database;
determining, by the computing device, that the one or more social media interactions correspond to the one or more records of sale for the one or more products;
recording, by the computing device, the one or more records of sale in the blockchain database as one or more subsequent blocks linked to the one or more blocks associated with the one or more social media interactions;
providing, by the computing device, an incentive to the customer in response to the one or more records of sale, wherein the incentive is proportional to the number of records of sale performed in response to the one or more social media messages recorded in the blockchain database;
after presenting the subset of the set of users to the customer, identifying, by the computing device, a downstream user of the subset of users as an influential user;
detecting, by the computing device, a second triggering event, wherein the second triggering event relates to a transaction by the downstream user related to one or more products; and
recording, by the computing device, the second triggering event in the blockchain database.

2. (canceled)

3. The method of claim 1, further comprising:
matching, by the computing device, a plurality of purchase records of the blockchain database to respective users of the set of users; and
creating, by the computing device and using the plurality of purchase records, spending profiles for respective users of the set of users, wherein determining the subset of the of users that satisfy the correlation threshold includes matching spending profiles of the subset of users to the one or more products.

4. The method of claim 1, wherein:
the social media network is a first social media network;
the set of users is a first set of users;
the subset of users is a first subset of users;
the downstream user of the first set of users manages a second social media network on the social media service, the second social media network including a second set of users that is different than the first set of users, and wherein identifying the downstream user as an influential user further comprises:
detecting, by the computing device and as a result of detecting and recording the one or more social media messages in the blockchain database, the downstream user posting an additional social media message that is substantially similar to the one or more social media messages to the second social media network;
detecting, by the computing device, an additional record of sale performed in response to the additional social media message; and
identifying, by the computing device and in response to the additional social media message and the additional record of sale, the downstream user as an influential user.

5. The method of claim 4, further comprising:
gathering, by the computing device and in response to the second triggering event, social media data from the second social media network of the downstream user, the social media data related to the second set of users; and
determining, by the computing device and using the gathered social media data, a second subset of the set of users that satisfy the correlation threshold indicating interest in the one or more products and the association threshold indicating an influence of the downstream user, wherein the downstream user satisfies the association threshold as a result of being identified as an influential user.

6. The method of claim 1, wherein;
the social media data includes at least one of profile posts of the users of the set of users or social media interactions between the customer and the users of the set of users;
the users of the subset of users satisfy the correlation threshold by having more than a threshold number of profile posts that relate to the one or more products; and
the users of the subset of users satisfy the association threshold by having more than a threshold number of social media interactions with the customer.

7. The method of claim 1, further comprising modifying, by the computing device, an amount of the incentive provided to the customer based on at least one of a correlation between the one or more products and the subset of users and an association between the customer and the subset of users.

8. The method of claim 1, further comprising providing, by the computing device, another incentive to the customer in response to detecting the social media message from the customer to the subset of users.

9. The method of claim 1, wherein:
the social media network is a first social media network;
the set of users is a first set of users;
the subset of users is a first subset of users;
the downstream user is in the first set of users and manages a second social media network on the social media service, the second social media network including a second set of users that is different than the first set of users, the method further comprising:
after recording the second triggering event, gathering, by the computing device, additional social media data from the second social media network related to a set of users;
determining, by the computing device and using the gathered additional social media data, a second subset of the second set of users that satisfy the correlation threshold and the association threshold;
detecting, by the computing device, one or more additional social media messages sent to the second subset of users by the downstream user using the social media service, the one or more additional social media messages relating to the one or more products;
recording, by the computing device, the one or more additional social media messages in the blockchain database as one or more blocks linked to the one or more blocks associated with the second triggering event;
detecting, by the computing device, an additional record of sale performed in response to the one or more additional social media messages;
recording, by the computing device, the additional record of sale in the blockchain database as a subsequent block linked to the one or more blocks associated with the one or more additional social media messages; and
providing, by the computing device, an incentive to the downstream user in response to the additional record of sale.

10. The method of claim 1, wherein:
the social media network is a first social media network;
the set of users is a first set of users;
the subset of users is a first subset of users;
the downstream user of the first set of users manages a second social media network on the social media service, the second social media network including a second set of users that is different than the first set of users, and
the method further comprises:
detecting, by the computing device, one or more additional social media messages sent to the second set of users by the downstream user using the social media service, the one or more additional social media messages relating to the one or more products;
recording, by the computing device, the one or more additional social media messages in the blockchain database as one or more blocks linked to the one or more blocks associated with the second triggering event;
detecting, by the computing device, one or more additional records of sale for the one or more products performed by the users of the second set of users in response to the one or more additional social media messages tracked in the blockchain database; and
recording, by the computing device, the one or more additional records of sale in the blockchain database as one or more subsequent blocks linked to the one or more blocks associated with the one or more additional social media messages.

11. (canceled)

12. The method of claim 1, further comprising creating, by the computing device, a social media message for the customer to send to a user of the subset of users based on post data of the customer and the user.

13. A computing device comprising:
at least one processor; and
a memory coupled to the processor, the memory storing instructions that, when executed, cause the at least one processor to:
detect a first triggering event, wherein the first triggering event relates to a transaction by a customer related to one or more products, and wherein the customer manages a social media network on a social media service;
record the first triggering event in a blockchain database as one or more originating blocks;
after recording the first triggering event, gather social media data from the social media network of the customer, the social media network including a set of users that are virtually connected to the customer on the social media service and the social media data related to the set of users, wherein the social media data includes user data that includes identifying information related to respective users of the set of users and post data that includes virtual content created by one or more users of the set of users;
determine, using the gathered social media data, a subset of the set of users that satisfy a correlation threshold indicating an interest in the one or more products and an association threshold indicating an influence of the customer;
present, to the customer, the subset of the set of users;
detect one or more social media messages sent to users of the subset of users by the customer using the social media service in response to the presenting of the subset of the set of users, the one or more social media messages relating to the one or more products, and the one or more social media messages each including a token that includes at least one of unique text or a hyperlink that generates routing metadata when executed;
record the one or more social media messages as one or more blocks in a blockchain database as one or more subsequent blocks linked to the one or more blocks associated with the first triggering event;
track one or more social media interactions of the downstream user to the one or more social media messages using the corresponding token received with the respective social media interaction;
record the one or more social media interactions in the blockchain database as one or more subsequent blocks linked to the one or more blocks associated with the one or more social media messages;
after recording the one or more social media messages, detect one or more records of sale for the one or more products and performed by the users of the subset of users in response to the one or more social media messages recorded in the blockchain database;
determine that the one or more social media interactions correspond to the one or more records of sale for the one or more products;
record the one or more records of sale in the blockchain database as one or more subsequent blocks linked to the one or more blocks associated with the one or more social media interactions;
provide an incentive to the customer in response to the one or more records of sale, wherein the incentive is proportional to the number of records of sale performed in response to the one or more social media messages recorded in the blockchain database;
after presenting the subset of the set of users to the customer, identify a downstream user of the subset of users as a particularly influential user;
detect a second triggering event, wherein the second triggering event relates to a transaction by the downstream user related to one or more products; and
record the second triggering event in the blockchain database.

14. The computing device of claim 13, the memory further storing instructions that, when executed, cause the at least one processor to
match a plurality of purchase records of the blockchain database to respective users of the set of users; and
create, using the plurality of purchase records, spending profiles for respective users of the set of users, wherein determining the subset of the of users that satisfy the correlation threshold includes matching spending profiles of the subset of users to the one or more products.

15. The computing device of claim 13, wherein:
the social media network is a first social media network;
the set of users is a first set of users;
the subset of users is a first subset of users;
the downstream user of the first set of users manages a second social media network on the social media service, the second social media network including a second set of users that is different than the first set of users, and
to identify the downstream user as an influential user, the memory further stores instructions that, when executed, cause the at least one processor to:
detect, as a result of detecting and recording the one or more social media messages in the blockchain database, the downstream user posting an additional social media message that is substantially similar to the one or more social media messages to the second social media network;
detect an additional record of sale performed in response to the additional social media message; and
identify, in response to the additional social media message and the additional record of sale, the downstream user as an influential user.

16. The computing device of claim 15, the memory further storing instructions that, when executed, cause the at least one processor to:
gather, in response to the second triggering event, social media data from the second social media network of the downstream user, the social media data related to the second set of users; and
determine, using the gathered social media data, a second subset of the set of users that satisfy the correlation threshold indicating interest in the one or more products and the association threshold indicating an influence of the downstream user, wherein the downstream user satisfies the association threshold as a result of being identified as an influential user.

17. A non-transitory computer-readable medium comprising instructions, that when executed, cause one or more processors of a computing device to:
detect a first triggering event, wherein the first triggering event relates to a transaction by a customer related to one or more products, and wherein the customer manages a social media network on a social media service;
record the first triggering event in a blockchain database as one or more originating blocks;
after recording the first triggering event, gather social media data from the social media network of the customer, the social media network including a set of users that are virtually connected to the customer on the social media service and the social media data related to the set of users, wherein the social media data includes user data that includes identifying information related to respective users of the set of users and post data that includes virtual content created by one or more users of the set of users;
determine, using the gathered social media data, a subset of the set of users that satisfy a correlation threshold indicating an interest in the one or more products and an association threshold indicating an influence of the customer;
present, to the customer, the subset of the set of users;
detect one or more social media messages sent to users of the subset of users by the customer using the social media service in response to the presenting of the subset of the set of users, the one or more social media messages relating to the one or more products, and the one or more social media messages each including a token that includes at least one of unique text or a hyperlink that generates routing metadata when executed;
record the one or more social media messages as one or more blocks in a blockchain database as one or more subsequent blocks linked to the one or more blocks associated with the first triggering event;
track one or more social media interactions of the downstream user to the one or more social media messages using the corresponding token received with the respective social media interaction;
record the one or more social media interactions in the blockchain database as one or more subsequent blocks linked to the one or more blocks associated with the one or more social media messages;
after recording the one or more social media messages, detect one or more records of sale for the one or more products and performed by the users of the subset of users in response to the one or more social media messages recorded in the blockchain database;
determine that the one or more social media interactions correspond to the one or more records of sale for the one or more products;
record the one or more records of sale in the blockchain database as one or more subsequent blocks linked to the one or more blocks associated with the one or more social media interactions;
provide an incentive to the customer in response to the one or more records of sale, wherein the incentive is proportional to the number of records of sale performed in response to the one or more social media messages recorded in the blockchain database;
after presenting the subset of the set of users to the customer, identify a downstream user of the subset of users as a particularly influential user;
detect a second triggering event, wherein the second triggering event relates to a transaction by the downstream user related to one or more products; and
record the second triggering event in the blockchain database.

18. The non-transitory computer-readable storage medium of claim 17, further comprising instructions that, when executed, cause the processor to:
match a plurality of purchase records of the blockchain database to respective users of the set of users; and
create, and using the plurality of purchase records, spending profiles for respective users of the set of users, wherein determining the subset of the of users that satisfy the correlation threshold includes matching spending profiles of the subset of users to the one or more products.

19. The non-transitory computer-readable storage medium of claim 17, wherein:
the social media network is a first social media network;
the set of users is a first set of users;
the subset of users is a first subset of users;
the downstream user of the first set of users manages a second social media network on the social media service, the second social media network including a second set of users that is different than the first set of users, and
to identify the downstream user as an influential user, non-transitory computer-readable storage medium further comprises instructions that, when executed, cause the processor to:
detect, as a result of detecting and recording the one or more social media messages in the blockchain database, the downstream user posting an additional social media message that is substantially similar to the one or more social media messages to the second social media network;
detect an additional record of sale performed in response to the additional social media message; and
identify, in response to the additional social media message and the additional record of sale, the downstream user as an influential user.

20. The non-transitory computer-readable storage medium of claim 19, further comprising instructions that, when executed, cause the processor to:
gather, in response to the second triggering event, social media data from the second social media network of the downstream user, the social media data related to the second set of users; and
determine, using the gathered social media data, a second subset of the set of users that satisfy the correlation threshold indicating interest in the one or more products and the association threshold indicating an influence of the downstream user, wherein the downstream user satisfies the association threshold as a result of being identified as an influential user.

21-23. (canceled)
